(19) United States
(12) Patent Application Publication
(10) Pub. No.: US 2012/0236543 A1
(43) Pub. Date: Sep. 20, 2012

(54) Flashclip

(76) Inventor: Mark Cameron Torgerson, Somerville, MA (US)

(21) Appl. No.: 13/065,099

(22) Filed: Mar. 14, 2011

(51) Int. Cl. F21V 21/084

(52) U.S. Cl. 362/106

(57) ABSTRACT

A device for holding an independently introduced flashlight to the visor of a common baseball cap or its facsimile. The purpose is to provide a convenient and simple means for carrying on one's person, a hands-free and directed light source by interfacing a cap and flashlight. It is more for use on a soft cap with a stiff visor or brim than a hard hat. Said flashlights normally contain light emitting diodes (LEDs) or incandescent bulbs. The device is comprised of two clips that are permanently fastened together. One clip holds the flashlight which is snapped into position, the other attaches to the cap.

### FIELD OF INVENTION

The Flashclip provides a secure and easily manageable mechanism for attaching a small flashlight to a baseball-style cap.

### BACKGROUND OF INVENTION

Methodologies for producing headgear illumination with hats and flashlights have settled on two distinct approaches for combining the three independent parts/components together—a cap or hat, a light source and an attaching device. One method combines a light source and attachment clip manufactured into one integrated piece. The second method is to provide a specifically designed independent “clip” for attaching auxiliary flashlights to hats or caps. This invention is an example of the second method, being a design for just the clip itself. “The Flashclip” represents an improvement over prior art in this category.

Flashlights for this purpose are inherently limited in size as to fit into the assembly of a clip and onto a cap visor. In examining prior art, for the most part, each design only works well with a specific size and/or shape of flashlight. Although flashlights used to mount on caps will probably have to be relatively small compared to hand-held flashlights, there is still ample room for improvement over prior art in managing these limitations.

Whether they are strapped directly onto the head or manufactured in one or separate components, all state of the art headlamp devices achieve at least a partial or even adequate solution to the hands-free illumination problem, but all have some similar and some different drawbacks. It is these drawbacks that represent the limitations of prior art and potential use of these designs.

The drawbacks are of three basic categories:

### 1] Comfort

Field tests reveal that the extra weight of a small flashlight itself on the head is not noticeable enough to be considered uncomfortable to a typical human user. However, if that weight ends up by constantly pulling the carrying cap down over the eyes, then the extra weight does become uncomfortable to carry. Testing reveals a visor/brim which is uncomfortably “front” loaded in weight may require frequent attention and adjustment or require the hat's strap to be secured uncomfortably tight; so as to be awkward or uncomfortable for extended usage.

U.S. Pat. No. 5,199,780, Ekman holds a flashlight forward and well off the front of the cap visor. This is likely to cause comfort difficulties. None of the designs of prior art adequately address this problem. Some designs involve built-in tipping and adjusting features, which occur on the front of the hat's brim or visor. e.g. U.S. Pat. No. 4,406,040 Cannone.

### 2] Versatility: Limitations in Size, Shape and On/Off Switching of Flashlights Introduced

A look at current designs reveals attempts to mount to multiple surfaces but no attempts to accommodate a range in size and shape of flashlights that will clip into their holster or clip. e.g. U.S. Pat. No. 6,206,543, Henry; U.S. Pat. No. 6,604,837, Sandberg; U.S. Pat. No. Des. 354,677, Troyer. Some of these designs, by their own admission, are meant to work with a specific size or barrel shape. In addition, some designs hold the flashlight down close to the surface of the hat's visor. This kind of configuration limits flashlight length to whatever fits on the visor, since a longer flashlight would likely bump into the head while in place. e.g. U.S. Pat. No. 6,206,543, Henry; U.S. Pat. No. Des. 354,677, Troyer.

### 3] Material Limitations

The spring and material characteristics required for attaching to a hat may be different than what is needed for holding a flashlight. Where a design is all one piece, this issue may be poorly addressed. U.S. Pat. No. 6,604,837 shows a clip requiring a material that is malleable enough to change positions for flashlight adjustment. It is unlikely that such a material will change to alternate angles yet also maintain consistent and constant spring pressure to grip a hat.

### 4] Complexity and Expense

In usage considerations, attempting to mount to hats, bicycle handle bars, mounting to tables and other configurations with one clip might limit a device from performing one task well.

Some designs, which integrate more of the components together, run on relatively expensive batteries that are not easy to acquire. Some combination designs can be expensive to acquire; enough so, as to remain primarily specialty items in specialty stores. Thus many potential users are discouraged from the benefits of their use.

### SUMMARY OF THIS INVENTION

The Flashclip provides an improved mechanism over prior art for interfacing small flashlights and baseball caps (or a facsimile) in the field of headgear illumination. It was born out of a need while performing manual tasks such as those of a tradesman. It is meant to be convenient and simple to interface with these other common items. There may be many circumstances in which a comfortable and versatile cap-light may be useful.

A word about the other components discussed here, baseball caps and flashlights:

Current technology places LED illumination at the forefront in small flashlight production. Because they are high in luminosity, light in weight and quite economical, small LED flashlights have become ubiquitous in homes and the marketplace. Baseball caps on their own typically provide a range of adjustment for different head size and up and down visor positions, and they have long been ubiquitous to the public at large. The Flashclip design interfaces with them for these reasons.

### 1] Comfort

The comfort of this design is achieved by orienting the flashlight's weight back off the front of the cap's visor and towards the head. Two features of the “flashlight clip” are responsible (see Clip #1 in Brief Description of Invention). The net result is less hat slippage, better balancing and a more comfortable feel for extended use, while avoiding potential fatigue and frustration.

### 2] Vesatility

The versatility of this design is in the large variety of flashlight sizes and on/off switching arrangements that can be accommodated. The flashlight retainer clip (clip #1) employs three separate bends—two for flexing/clamping (spring tension and release) and one for positioning the flashlight in place. Flashlights that switch on/off at the rear (the majority of LED flashlights), on the side or twisting in the front can be operated while the cap is in position on the head. The Flashclip performs well with common LED or incandescent flashlights in the size range of ˜3 to 6 inches in length, and ¾ to 1¼ inches in width (barrel dimension). This size range is characteristic of most LED flashlights currently found in today's marketplace. Because of weight considerations, smaller sizes are better. Commonly available batteries power most of these flashlights.

3] Materials The Flashclip is designed with two independent clips or springs, each of which can be comprised of an appropriate material for the specific function performed. Both spring steel and or plastic would be available. An appropriate configuration can be achieved using 50 or 75 carbon spring steel for clip/spring #1 (holding flashlight) and 1095 blue spring steel for clip/spring #2 (attaching to the hat).

### 3] Complexity and Expense

The Flashclip is simple and convenient. It can be stored on a hat waiting for a flashlight or clipped to a flashlight waiting for a cap. It is designed to do one operation well—hold a flashlight and mount to a cap. No attempt has been made to clip onto many configurations as in U.S. Pat. No. 6,206,543; Henry. Aiming of the light is sufficiently achieved by moving the cap and visor up and down or side to side.

The Flashclip is relatively easy to manufacture. It can be produced relatively inexpensively using standard common spring steel. Flashlights used in the Flashclip are generally powered by inexpensive batteries; batteries that are found ubiquitously in the marketplace.

### BRIEF DESCRIPTION OF INVENTION

This invention consists of two integrated clips or springs, comprised of common flat spring steel or the plastic equivalent. When comprised of metal, the two clips can be either riveted together or spot-welded together. The two clips together form the invention, which is referred to here as the “Flashclip”. The Flashclip is easily installed or removed, with no negative impact, from or on the other components (hat and flashlight).

Clip #1—The “flashlight clip” (or spring) grabs the barrel of the flashlight in a similar way that a utility broom clip/clamp holds a broom vertically in a utility closet, or a microphone holder grabs and secures a microphone (FIG. 2, 4). The design of this clip allows a flashlight to “snap in” far enough above the hat brim/visor to allow for longer and shorter length flashlights. This “flashlight clip” is also positioned well back on the visor—away from the front edge, allowing all of the flashlight body to be at or behind the front edge of the visor. Together, these two features allow forward and aft adjustability of a flashlight while in position. Both clips can be made of metal or plastic or a combination of these materials. The clips would either be fastened together or permanently fused together. A common rivet works well in joining two shaped metal springs.

Clip #2—The “hat clip” (or spring) is for attaching the device onto a standard baseball cap or any hat with a similar stiff brim at the front of the hat. The “hat-clip” is a single flat piece of bifolded metal or plastic that slides onto and wraps over the top and bottom sides of the hat visor/brim (FIG. 1, 2). This clip is shaped to easily slip over the front brim of the hat and using proper spring tension to stay firmly attached to the brim.

### BRIEF DESCRIPTION OF THE DRAWING

FIG. 1 is a view of the Flashclip attached to the cap; to be used as Front Page view

FIG. 2 is the same view with a flashlight mounted in the clip; all three components are shown

FIG. 3 is a view of the Flashclip showing both springs/clips fastened together; with the upper clip, the flashlight clip, riveted to the lower clip, the hat clip

FIG. 4 is a repeat of FIG. 3 with a flashlight mounted in the device

FIG. 5 is a front elevation of the entire clip only

FIG. 6 is a side elevation of the entire clip only

FIG. 7 is another view of FIG. 1

FIG. 8 is another view of FIG. 2

### DETAILED DESCRIPTION OF THE DRAWINGS

The Flashclip or “attachment” 10 is comprised of two clips, the “flashlight clip” 11 and the “hat clip” 12 or “brim” clip. These two clips each serve a different purpose and are joined together by a fastener/retainer 19 (FIG. 5) to become the “attachment” 10.

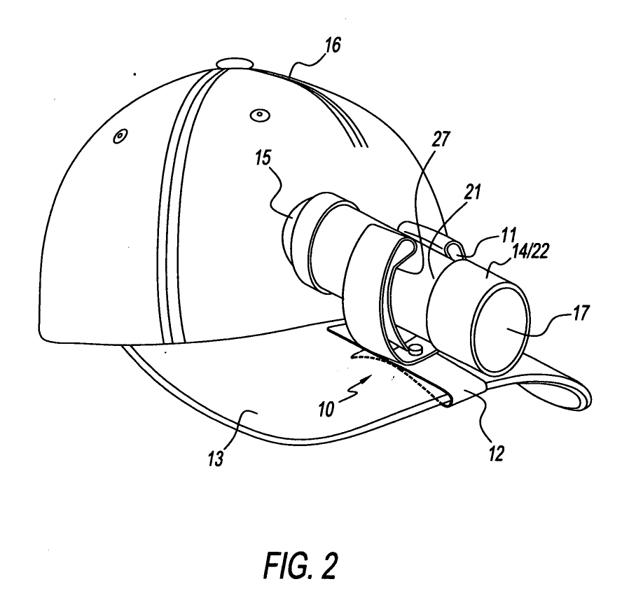

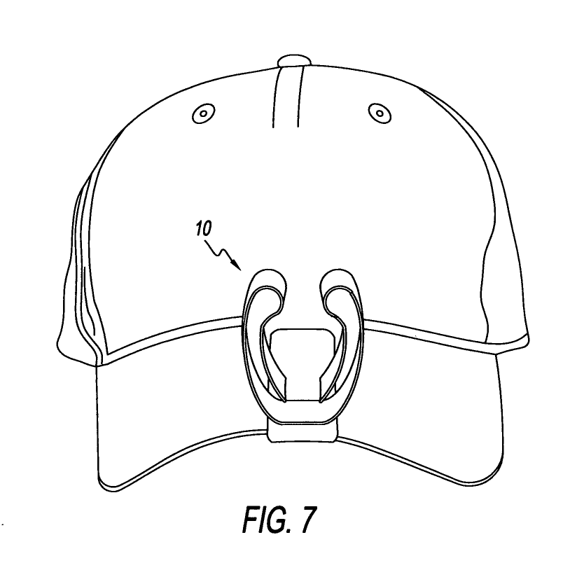

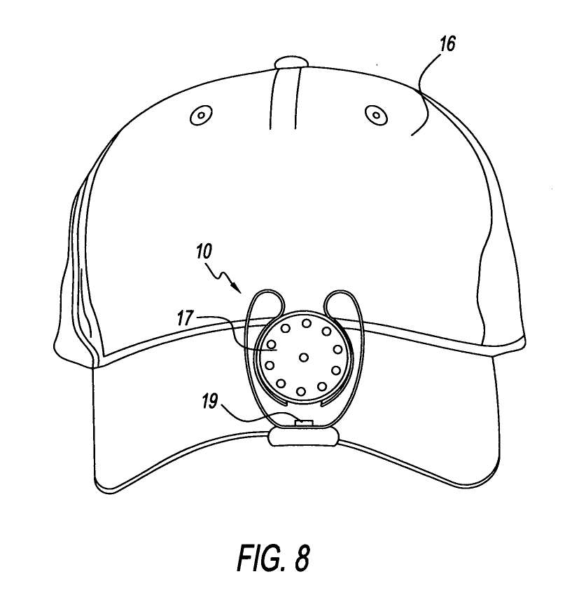

The flashlight clip 11 is comprised of a general “u” shape with two bends, 20 and 20a (FIG. 5), for contacting and holding the flashlight itself. The approximate width of this clip 11 (FIG. 6) would be wide enough to provide proper strength and spring tension, but narrow enough (˜½ to ¾ inches) to allow the flashlight “belly” 21 to have adequate room to move forward or back on the hat's brim. This clip 11 can be constructed of metal or plastic—which ever has the preferable combination of spring tension, durability, lightweight and cost. It is possible to hold the flashlight in just a single “U” shape (with one bend 20a), but the additional bend 20 along with the overall “U” shape of the clip 11 allows for spring tension to be distributed to two bends 20, 20a instead of just one (FIG. 2). The two bends, 20 and 20a, give the clip 11 increased spring tension i.e. “grabbing force” and more flexibility for flashlights of smaller or larger barrel-sizes 21.

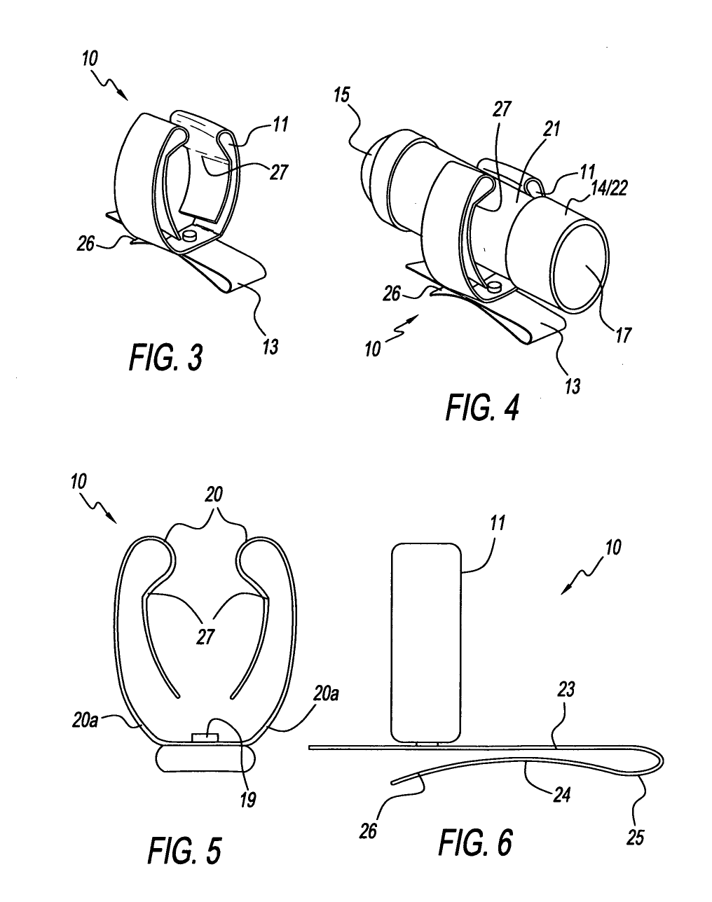

A third bend 27 in the flashlight clip 11 is shaped in a curve with very slight (gradual) “V” in order to firmly grasp the flashlight; the “V” helps to grab generally round flashlights of different barrel size (FIG. 3, 5). The positioning of the center of this bend 27 should be “high” enough above the hat's brim to allow for maximum (backwards or forwards) adjustment of a flashlight body towards and away from the dome of the cap 16; or even over the dome of the cap 16 with a longer length flashlight than shown 14 (FIG. 2. 4). The user will be able to easily operate the on and off switch 15 with the flashlight 14 slid all the way back to or over the cap 16 on the head of the user. A flashlight with the on/off switch on the side or barrel 21 of the flashlight will also be able to turn the unit on and off with the cap 16 and apparatus in position on the head of the user. If the flashlight uses a twist on/off feature 22, this can be operated in position.

It should be noted that when a baseball cap is on the head of a user, the brim of the hat is actually near the top of the head. Conversely, the dome of the cap is actually above the actual top of the user's head. With the hat in position, bend 27 will hold the barrel of the flashlight just above the top of a typical person's head.

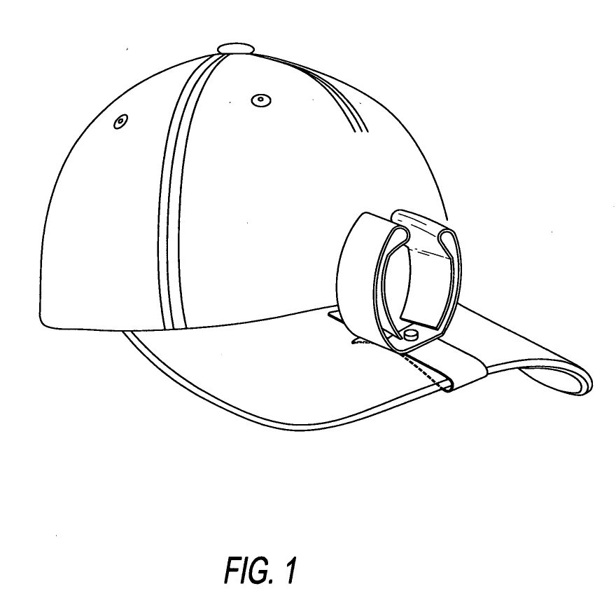

The hat or “brim” clip 12 is comprised of a length of flat spring steel or plastic (˜6 inches in length and ˜¾ in width) which is bifolded, flat against flat (FIG. 6), and given a flare 26 to slid onto the caps lid or brim/visor 13 and stay firmly affixed by means of spring tension (FIGS. 1, 2). The flat spring steel (or plastic) needs to be wide enough, approx. ½ to ¾ inch, to avoid a rocking effect when attached to the brim. The opposing or bifolded sections of spring material 23, 24 grab and hold the brim 13 by way of the bend 25 in the clip 12. Spring/clip 12 shall be permanently fastened or fused to the flashlight clip 11 in a perpendicular arrangement (FIG. 5, 6); by a common rivet 19 or a spot-weld if spring steel is used. Bend 25 shall be bent (slightly “over-bent”) to allow the clip 12, in its entirety, to squeeze the brim 13 with proper spring tension as to allow the apparatus to slide onto the brim and then stay firmly attached to the brim 13.

When mounted in position, the LED lens 17 will be even with, slightly ahead of, or slightly behind the front edge (rim) of the visor of the cap (FIG. 2, 4). The average brim/visor of a typical baseball cap being approximately 2¾ to 3 inches front to back (FIG. 2).

1. A two-way fastening clip comprised of an upper spring clip and a lower spring clip, which consist of flat spring material and are perpendicularly joined, for releaseably holding a flashlight and a cap or hat visor simultaneously

2. The combination defined in claim 1, wherein the upper clip, or flashlight clip, positions the body of a flashlight behind the front edge of the cap's brim and towards the dome of said cap

3. The combination defined in claim 1, wherein the upper clip, or flashlight clip, holds a flashlight high enough above the cap's visor to allow clearance for forward and backward adjustment of said flashlight while in position on the head

4. A two-way fastening clip containing an upper spring clip, and consisting of flat spring material, for releaseably holding a flashlight and comprised of three opposing bends for exerting spring pressure

5. The combination defined in claim 4, wherein two of the three opposing bends are for exerting releasable spring pressure on the body or barrel of a flashlight

6. The combination defined in claim 4, wherein one of three opposing bends consists of a slight “V” shape for securing the precise location of an introduced flashlight

7. A two-way fastening clip containing a lower clip, and consisting of flat spring material, comprised of two bends for releasably holding the visor or brim of a cap

8. The combination defined in claim 7, wherein one bend results in a flared end for allowing easy sliding on and off of said cap's visor or brim

9. The combination defined in claim 7, wherein one bend is in a bifold manner and is slightly over-bent to create a uniform pressure along the top and bottom side of the cap's visor
